(19) United States
(12) Patent Application Publication
(10) Pub. No.: US 2016/0297474 A1
(43) Pub. Date: Oct. 13, 2016

(54) STEERING APPARATUS WITH MULTI-STEERING MODES

(71) Applicant: DongFeng Shi, Sammamish, WA (US)

(72) Inventor: DongFeng Shi, Sammamish, WA (US)

(21) Appl. No.: 15/001,622

(22) Filed: Jan. 20, 2016

Related U.S. Application Data
(63) Continuation-in-part of application No. 14/682,750, filed on Apr. 9, 2015, now Pat. No. 9,376,141.

(51) Int. Cl. B62D 7/15; B62D 5/00

(52) U.S. Cl. CPC B62D 7/1509; B62D 7/1545; B62D 5/00

(57) ABSTRACT

The present invention relates to a steering system that allows the user to switch between a first steering mode and a second steering mode by a purely mechanical means. This includes, but is not limited to, switching from an all-wheel steering mode to a crab travel mode. The four wheel steering system includes a chassis, a front wheel steering system, a rear wheel steering system, and a steering control link that connects the front wheel steering system and the rear wheel steering system. The four wheel steering system also includes a steering interchange that mechanically switches the steer of the attached vehicle from one mode to a second mode.

### CROSS REFERENCE TO RELATED APPLICATIONS

This application claims priority to co-pending U.S. application Ser. No. 14/682,750 filed on Apr. 9, 2015 which is hereby incorporated by reference for all purposes.

### BACKGROUND

The present disclosure relates generally to steering systems in vehicles. In particular, steering systems where the vehicle switches from a crab travel mode of steering to a second front wheel mode of steering through mechanical means are described.

Known steering systems are not entirely satisfactory for the range of applications in which they are employed. For example, existing steering systems tend to be complex and require specialized components such as microprocessors, sensors, and complex electronic circuitry. In addition, not only are conventional steering systems more complex, but also more costly.

Thus, there exists a need for steering systems that are less complex and costly than the design of known steering mode changers/shifters. Examples of references relevant to steering interchange systems include U.S. Patent References: U.S. Pat. No. 6,371,243 to Donaldson (“Donaldson”), U.S. Pat. No. 7,278,511 to Gass (“Gass”), and U.S. Patent Application 20040129491 to Bean (“Bean”). The complete disclosures of the above patents and patent applications are herein incorporated by reference for all purposes.

Donaldson discloses a mobile personal lift that allows the operator to switch between different modes of steering. The Donaldson lift includes directional switches and steering mode selectors that are coupled to a microprocessor that operatively coupled to hydraulic cylinders located at each wheel. The microprocessor controls the hydraulic cylinders corresponding to each wheel to the selected steering mode and corresponding movement of the joystick. Sensors positioned adjacent to each wheel and connected to the microprocessor measure the angular position of each wheel relative to the longitudinal axis of the chassis. The information from the sensors is then transmitted to the microprocessor and used to synchronize the wheels.

Gass also discloses a mechanism for switching between different modes of steering. Gass discloses one or more actuators for selectively steering wheels of the vehicle. Gass discloses an electronic control unit that provides control signal to one or more rear wheels. When the vehicle operator determines a particular steering mode is appropriate for the present riding conditions, an input device may be used to produce an input signal. A vehicle in accordance with the present invention, may also comprise an electronic control unit (ECU) coupled to a plurality of sensors. The ECU may compare a first riding parameter to a second riding parameter in order to determine whether operation in a second steering mode is appropriate, in light of present riding conditions. The ECU may produce an enabling signal when the ECU determines that operation in the second steering mode is appropriate for the present riding conditions.

Bean also describes a vehicle operable in a plurality of steering modes including two wheel steering, crab steer, and coordinated steer. A wheel angle sensor is disposed in coordination with each wheel. The Bean vehicle also includes a hydraulic cylinder coupled with extendable and retractable axles. The hydraulic cylinders may be controlled to effect extension and retraction of the axles only when the vehicle is traveling above a predetermined minimum speed. Four digital or analog switches are coupled with the axles indicating when the axles are fully extended. The drive and steering functions are controlled according to signals from the switches.

### SUMMARY

The present disclosure is directed to a steering system that allows the user to switch between a front wheel steering mode and a crab travel mode by a purely mechanical means. The four wheel steering system includes a chassis, a steering cylinder, a front wheel steering system, a rear wheel steering system, a steering control link system, and a steering mode interchanger that connects the front wheel steering system and the rear wheel steering system through the steering control link system. The front wheel steering system includes a front steering system crossbar that links a front left and right wheel bracket while a rear steering system crossbar links rear left and rear right wheel brackets.

### BRIEF DESCRIPTION OF THE DRAWINGS

FIG. 1 is a plan view of a steering system according to one embodiment of the present invention.

FIG. 2 is a side view of the steering system connected to the chassis according to one embodiment of the present invention.

FIG. 3 is a plan view of a steering system according to one embodiment of the present invention.

FIG. 4 shows the rear wheel steering system according to an embodiment of the present invention.

FIG. 5 shows the front steering system according to an embodiment of the present invention.

FIG. 6 is a top view of one embodiment the front steering system connected with the steering mode interchanger and steering cylinder according to an embodiment of the present invention.

FIG. 7 is a top view of the steering control link system according to an embodiment of the present invention.

FIG. 8A is a view of the housing of the steering mode interchanger.

FIG. 8B is a view of the sliding cradle and bushing of the steering mode interchanger.

FIG. 9A shows an exploded view of steering mode interchanger connected to the steering control link system and the rear wheel steering system according to an embodiment of the present invention.

FIG. 9B shows the steering mode interchanger connected to the front wheel steering system, the steering cylinder and the control link system according to the embodiment of the present invention.

FIG. 10 shows the rear L-shape pivot arm of the steering control link system according to an embodiment of the present invention.

FIG. 11A is an illustration of a first steering mode according to embodiment of the present invention.

FIG. 11B is an enlarged partial illustration of a first steering mode according to embodiment of the present invention.

FIG. 12A is an illustration of a second steering mode according to embodiment of the present invention.

FIG. 12B is an enlarged partial illustration of a second steering mode according to embodiment of the present invention.

FIG. 13 is an illustration of the mechanism by which the wheels are powered between steering modes.

### DETAILED DESCRIPTION

The disclosed steering system will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various steering mode are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The present disclosure relates to a mechanical system that switches the steering between the front wheel steering mode to a crab travel mode. Because the steering system is purely a mechanical system, there is no need for sensors, microprocessors, or expensive electronic circuitry. The absence of sensors, microprocessors, and expensive electronic circuitry allows the steering system to be built at a lower cost using simpler and less costly components and is, therefore, more reliable, more robust, and easier to repair.

The disclosed steering system is a mechanical mechanism that allows a motor vehicle to switch between the front wheel steering mode to a crab travel mode. Accordingly, two front wheel brackets pivot with respect to a front wheel crossbar so that both front wheels turn in the same direction. Similarly, two rear wheel brackets pivot with respect to a rear wheel crossbar such that all the rear wheels can turn to the same direction. The front wheels turn when the steering cylinder extends or retracts. Corresponding to the movement of the front wheels, the rear wheels steering system controls the rear wheels to turn in either in the same direction or keep straight depending on the steering mode interchanger action. In the front wheel steering mode, only the front wheels turn. In the crab travel mode, when the front wheels are turned, the rear wheels also turn in the same direction as the front wheels. The crab travel mode allows the vehicle to get into a space with straight movement and no turning action.

Each of the front wheels has its own drive motor and only one rear wheel has a drive motor. At any time, however, only two drive motors may be used concurrently. In the front wheel steering mode, the drive motors on the front wheels are activated and in the crab travel mode, the rear wheel motor and one of the front wheel motors is activated.

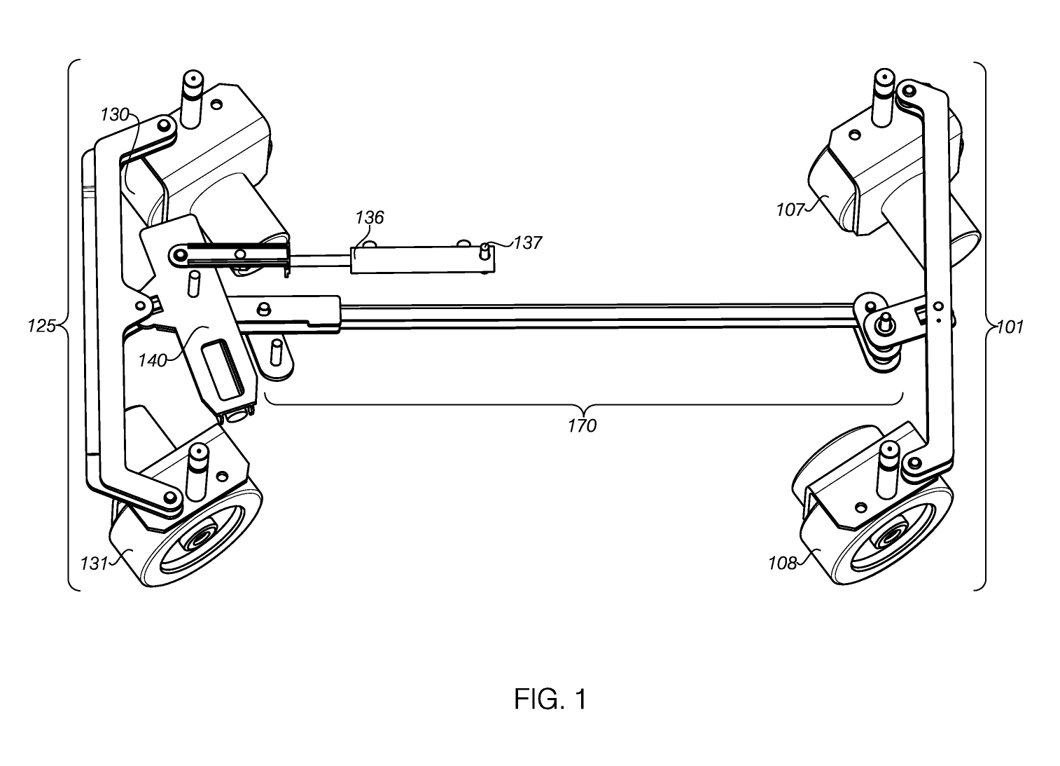

As shown in FIG. 1, steering control link system 170 connects the steering mode interchanger 140 and rear wheel steering system 101 together. In crab travel mode, steering control link system 170 transfers the steering force and movement from the steering cylinder 136 to the rear wheels 107/108 and thus allow the rear wheel 107/108 to steer together with front wheel 130/131 in the same direction and angle. In front wheel steering mode, steering control link system 170 holds the rear wheels 107/108 to be consistently parallel to the longitudinal direction of the chassis 171.

### Steering Control Link System

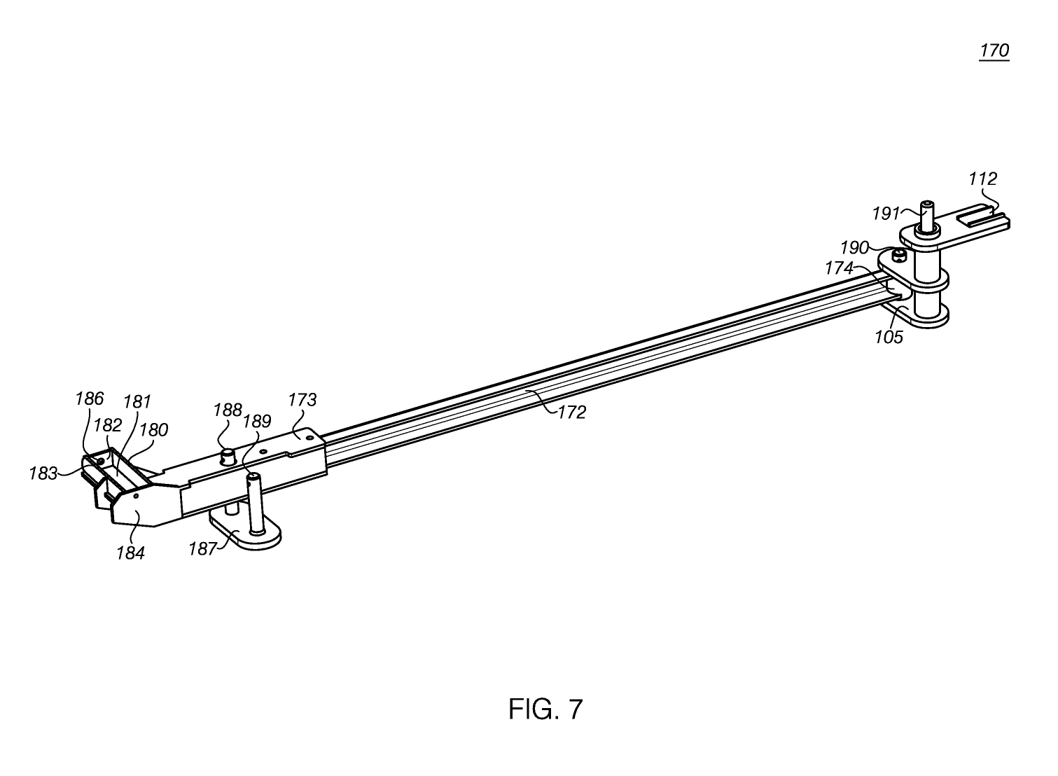

As shown in FIG. 7, steering control link system 170 further comprises a link 172, a front end 173 pivoted to front swing arm 187 by a first link pin 188. The rear end 174 of link 172 (the side closest to the rear wheel steering system 101) is pivoted to rear L-shape pivot arm 105 by a second link pin 190 as shown. Front swing arm 187 and rear L-shape pivot arm 105 are pivoted to the chassis 171 by a third link pin 189 and a fourth link pin 191 accordingly. Further, swing arm 18 7 and rear L-shape pivot arm 105 have the same arm length to connect the link 172 to the chassis 171 such that link 172 can only move parallel to the longitudinal direction of the motor vehicle and is always parallel to the longitudinal direction of chassis 171.

As shown in FIG. 7, steering control link front end 173 includes a groove 181 that is perpendicular to the longitudinal direction of the control link 172. This groove 181 has the front wall 183, rear wall 180, right wall 182 and left wall 184. This groove 181 interfaces with steering mode interchanger's cradle peg 143 (will describe later) and allow the peg to slide inside and along the groove when changing from one steering mode to another. Finally, the wheels' drive motor is activated depending on which steering mode is selected by a button switch 186 that is mounted on the right wall 182. Thus, when lower peg 143 slides to the right of the groove 181 and touches the right wall 182, it activates button switch 186 and puts the vehicle in crab travel mode. When button switch 186 is activated, it will allow only one of the front wheel motor and one rear wheel motor to be activated. So in crab travel mode, one rear wheel and one front wheel that is in the diagonal location of the rear motored wheel will be the driving wheels.

When lower peg 143 slides to the left of the groove 181 and touches the left wall 184, button switch 186 is deactivated, and the vehicle will be in front wheel steering mode. When vehicle is in front wheel steering mode, since button switch 186 is deactivated, the motors on the front wheels will be activated and the motor on the rear wheel will be deactivated. So in front wheel steering mode, only the two front wheels will be the driving wheels.

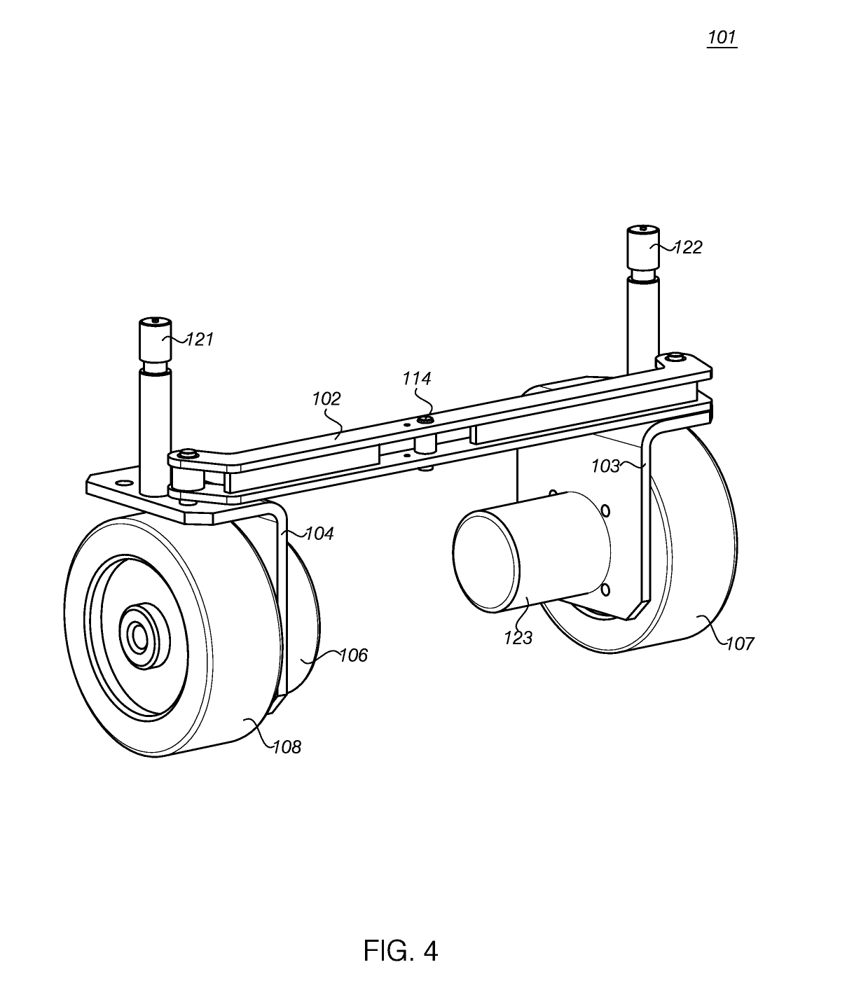

Steering control link system 170 further includes a rear L-shape pivot arm 105, also shown in FIG. 10. This rear L-shape pivot arm 105 includes a rear L-shape pivot arm top plate 109, a rear L-shape pivot arm middle plate 110, and a rear L-shape pivot arm bottom plate 111. They are connected together by a vertical tube 118 having a hole 119 disposed throughout. The top plate 109 further includes a rear groove 112. This rear groove 112 tangents with middle pin 114 of rear wheel crossbar 102 (pin 114 and crossbar 102 are shown in FIG. 4) such that when L-shape pivot arm 105 is turned by steering control link 172, crossbar 102 will move in the cross direction and thus push the rear wheel brackets/rear wheels to turn.

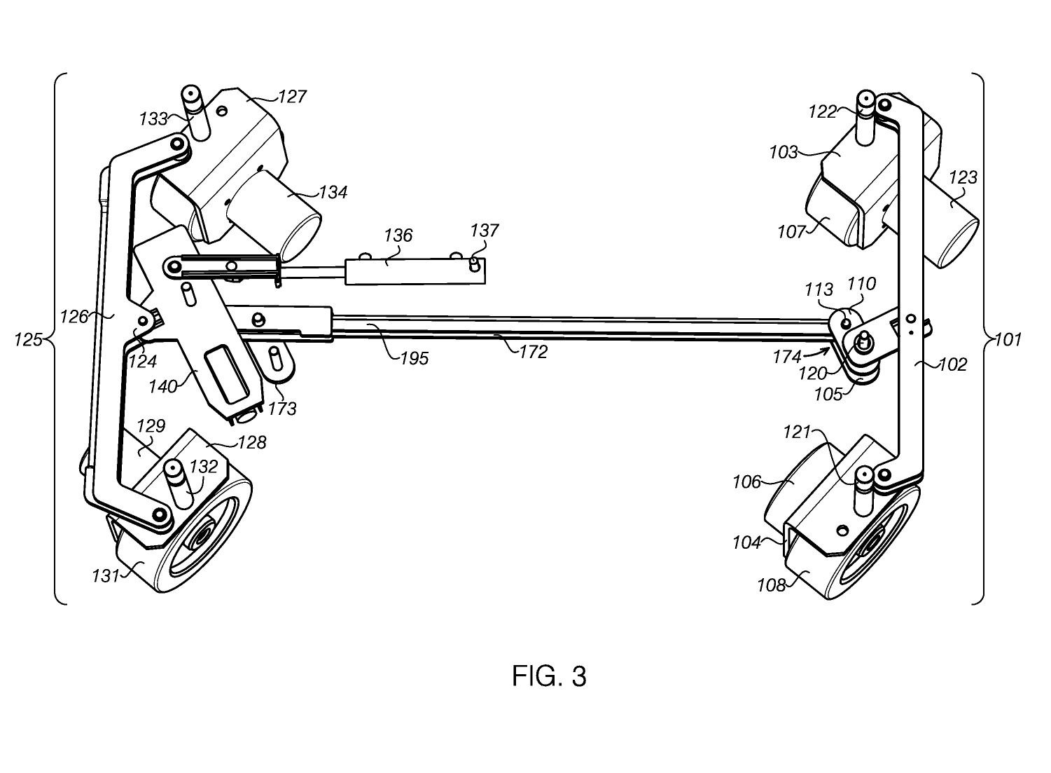

As shown FIG. 10, rear L-shape pivot arm middle plate 110 and rear L-shape pivot arm bottom plate 111 are parallel to each other but they are all perpendicular to the rear L-shape pivot arm top plate 109 in horizontal direction. These three plates are connected by a common tube 118 which goes through each plate. As shown in FIG. 3, a connecting pin 120 goes through tube 118 and pivots rear L-shape pivot arm 105 to chassis 171.

As shown in FIG. 10, rear L-shape pivot arm middle plate 110 further comprises a middle plate hole 115 which is concentric to a bottom plate hole 117 on rear L-shape pivot arm bottom plate 111. Steering control link 172's rear end 174 fits within the space between rear L-shape pivot arm middle plate 110 and rear L-shape pivot arm bottom plate 111 as shown in FIG. 7. Also shown in FIG. 7 is a connecting pin 190 that goes through middle plate hole 115 and bottom plate hole 117, and also through a hole in steering control link 172's rear end 174 so when control link 172 shifts forward and backward, it pushes rear L-shape pivot arm 105 to swing, which in turn causes the rear wheel crossbar 102 to push the rear wheels 107/108 to turn.

### Rear Steering System

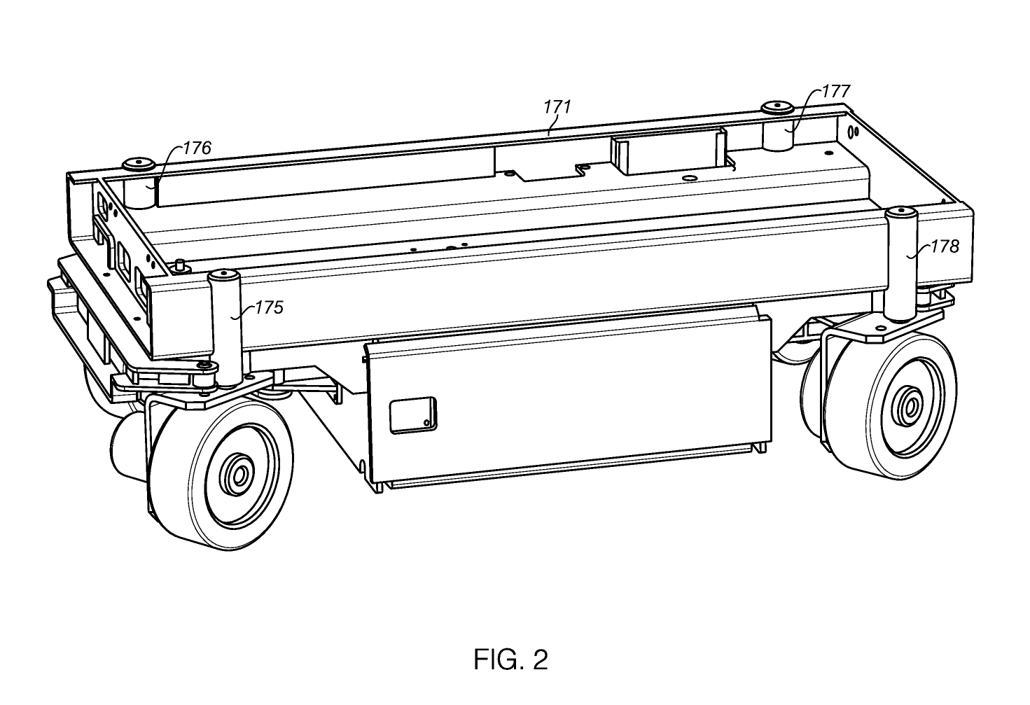

As shown in FIG. 3 and FIG. 4, rear steering system 101 includes a rear right wheel bracket 103, a rear left wheel bracket 104, connected by a rear crossbar 102 which has a pivot rod 114 in the middle area. Rear right wheel bracket 103 is coupled to rear right wheel 107 and rear left wheel bracket 104 is coupled to rear left wheel 108. When steering control link 172 moves back and forth, rear left wheel 108 and rear right wheel 107 are turned in response through real L-shape arm 105 and rear crossbar 102. Rear crossbar 102 is pivoted with respect to rear right wheel bracket 103 and rear left wheel bracket 104 so that rear right wheel 107 and rear left wheel 108 are always turned to the same direction during steering. The top end of rear right wheel bracket 103 includes a right rear wheel bracket pivot pin 122 and the top end of the rear left wheel bracket 104 includes a left rear wheel bracket pivot pin 121. As shown in FIG. 2, the right rear wheel bracket pivot pin 122 is inserted into the right rear wheel bracket pivot pin mating tube 177 on the chassis 171 and the left rear wheel bracket pivot pin 121 is inserted into left rear wheel bracket pivot pin mating tube 178 on the chassis 171 accordingly to connect the rear steering system 101 to the chassis 171.

Further disposed on rear left wheel bracket 104 is a rear wheel brake 106. Rear left wheel brake 106 stops rear left wheel 108 when the vehicle is not traveling. Further disposed on the rear right wheel bracket 103 is the rear right wheel motor 123 which is used to drive rear right wheel 107 in crab travel mode. Thus at any time, either the drive motor 123 or parking brake 106 is engaged so vehicles are either in driving condition or parking brake condition.

### Front Steering System

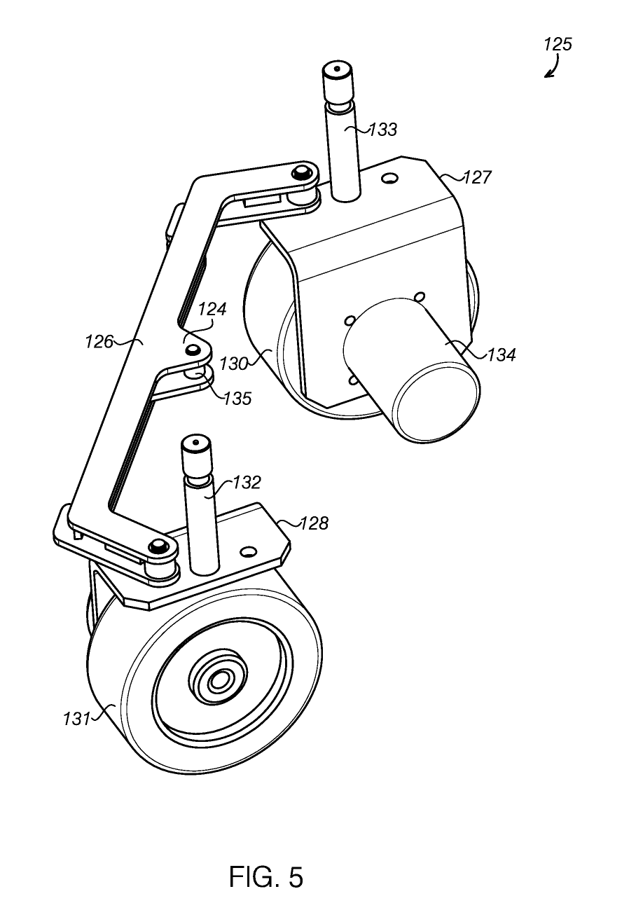

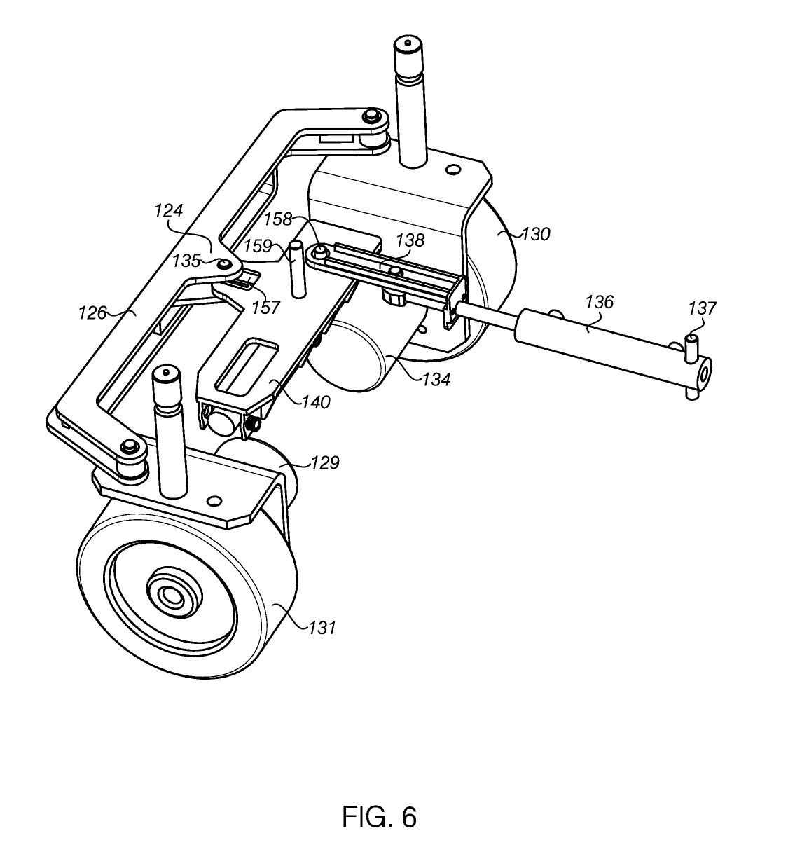

As shown in FIG. 5, front steering system 125 includes a front crossbar 126 having a central protrusion 124 which is bisected by pivot pin 135 and located substantially between the font wheels 130/131 as shown. Front steering system 125 further comprises a front right wheel bracket 127, a front left wheel bracket 128, a front right wheel 130, a front left wheel 131, a front left wheel drive motor 129 (shown in FIG. 6) and a front right drive motor 134. Front right wheel 130, coupled with front right drive motor 134, is disposed on the inner side of front right wheel bracket 127 as shown, and front left wheel 131, coupled with front left wheel drive motor 129, is disposed on the inner side of front left wheel bracket 128 as shown. Further, disposed on the top of front right wheel bracket 127 and on the top of front left wheel bracket 128 are a front right wheel bracket pivot pin 133 and a front left wheel bracket pivot pin 132.

When the vehicle is in front wheel steering mode, both front left wheel drive motor 129 and front right wheel drive motor 134 are activated to move the front wheels 131/130. When the vehicle is in crab travel mode, only the front left wheels drive motor 129 and rear right wheel drive motor 123 are activated to move the front left wheel 131 and real right wheel 107. Front right wheel bracket pivot pin 133 and front left wheel bracket pivot pin 132 are inserted and mated to right front wheel bracket pivot pin mating tube 176 and a left front wheel bracket pivot pin mating tube 175 on the chassis 171 (identified in FIG. 2) accordingly allowing the front steering system 125 to be connected to the chassis 171.

### Steering Mode Interchanger

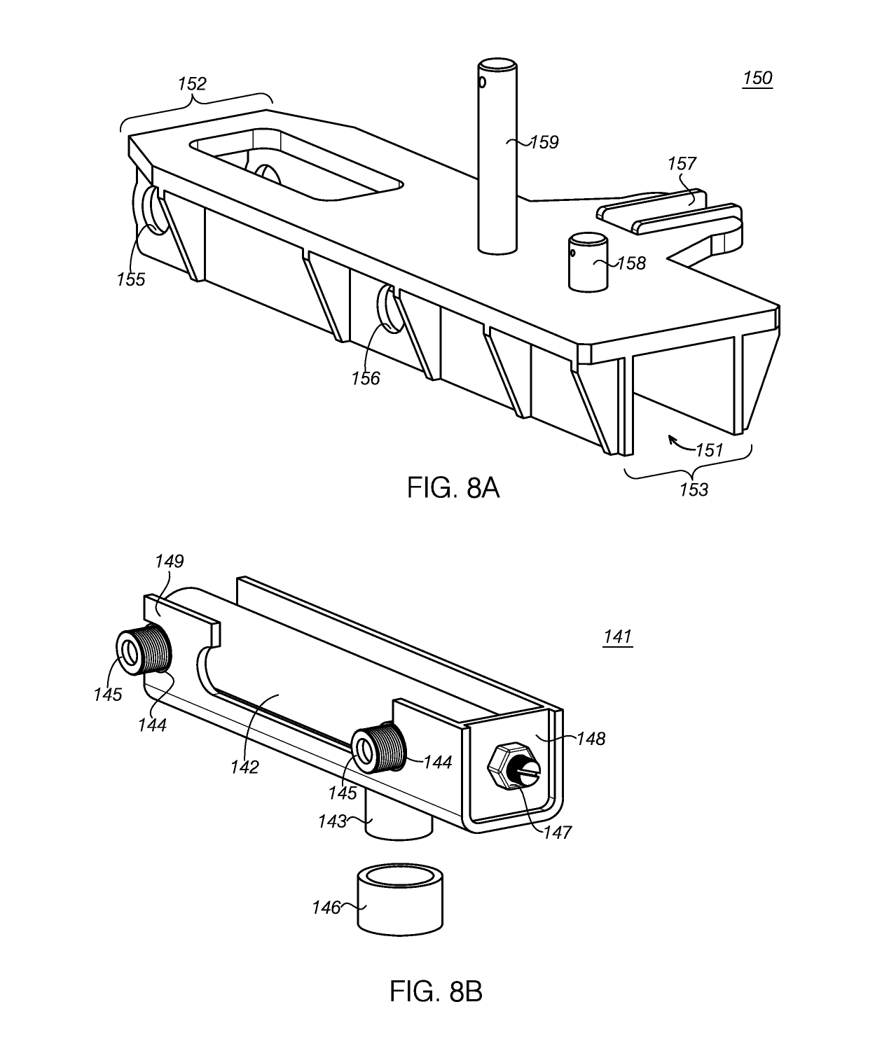

As shown in FIGS. 1 and 3, steering mode interchanger 140 is disposed between front steering system 125 and steering control link system 170. Referring, then, to FIG. 8A, steering mode interchanger 140 comprises a housing 150 having a channel 151 with a channel left side 152 and a channel right side 153. Housing 150 further comprises a first housing aperture 155, a second housing aperture 156, a housing groove 157, a housing pin 158 on the upper surface at the distal end of the housing that is to be pivoted to the steering cylinder 136 and a housing peg 159 on the middle upper surface that is to be pivoted to the chassis 171. The dimensions of channel 151 are complementary to sliding cradle 141(discussed in further detail below), thus channel 151 is configured to accommodate sliding cradle 141 and sliding cradle 141 can slide inside channel 151.

As shown in FIG. 8B, steering mode interchanger 140 further comprises a sliding cradle 141, with a sliding cylinder 142 sitting inside it. The sliding cylinder 142 have its threaded cylinder rod front end fixed to the cradle's right end wall 148 by nut 147. The sliding cylinder 142 has a pair of ports 145 on its body that face the back wall 149 of sliding cradle 141 and fit within the open space 144 on the wall 149. A lower peg 143 is located at the bottom of the cradle 141 and a bushing 146 is fitted to the lower page 143. The ports 145 are fixed to the first and second housing apertures 155/156 on housing 150. When sliding cylinder 142 extents, it will push the sliding cradle 141, via the right end wall 148, to slide inside channel 151, thus the lower peg 143 and its mated bushing 146 will also slide together with the sliding cradle 141.

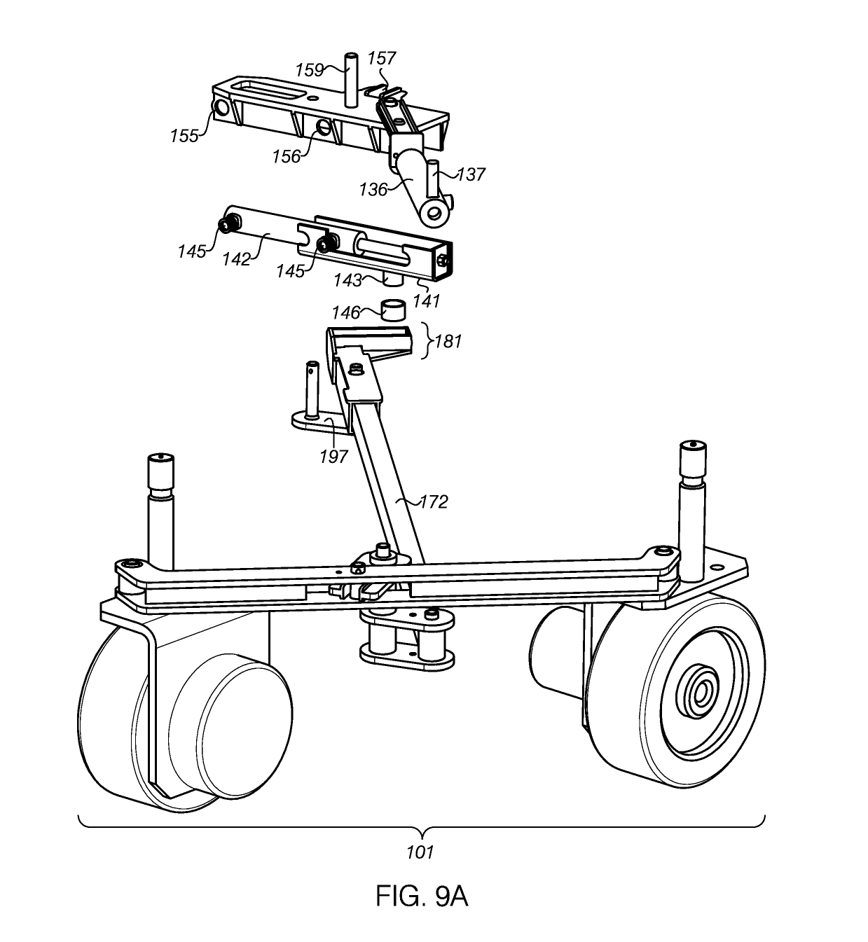

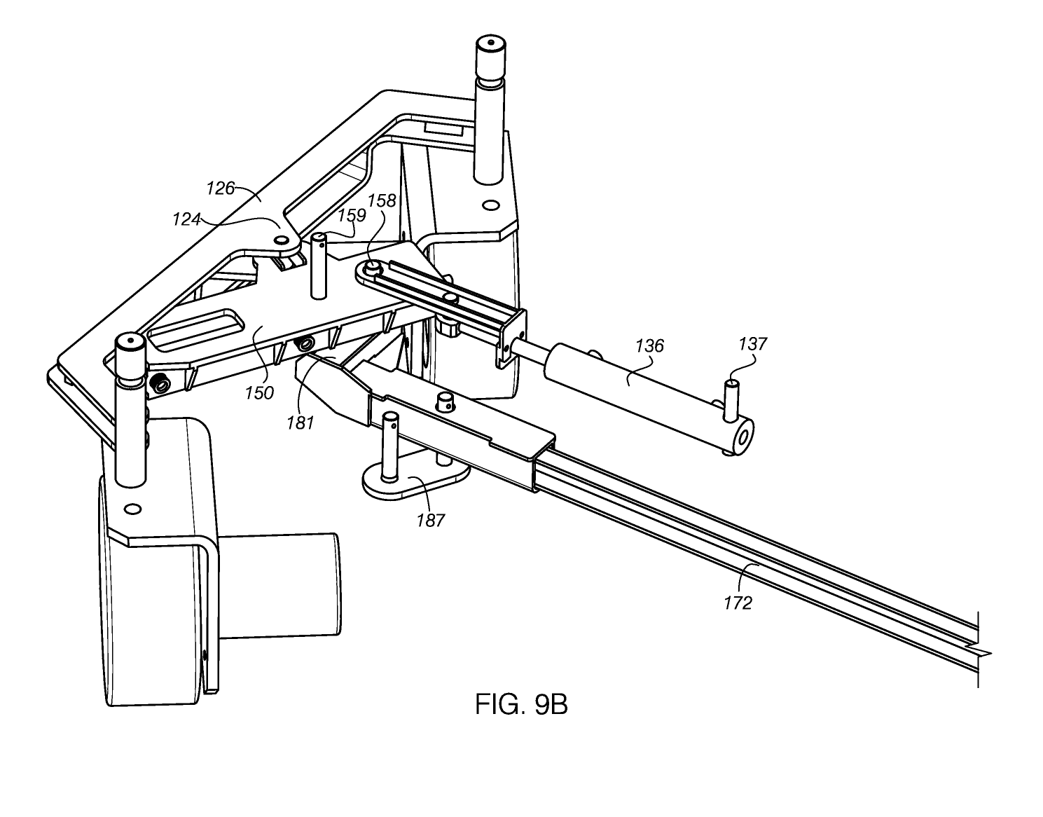

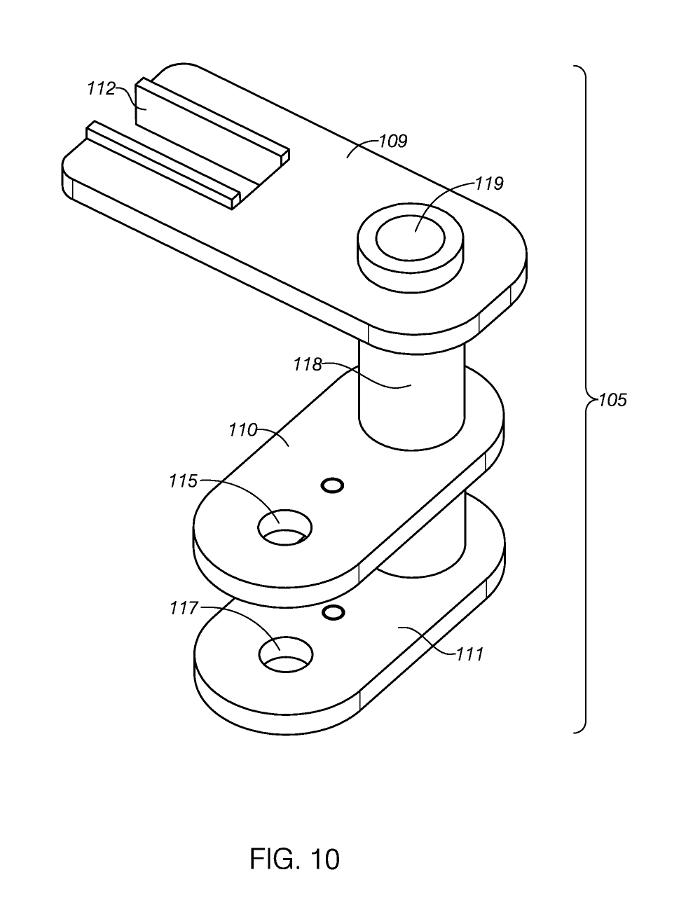

As shown in FIG. 6, housing groove 157 is configured to tangentially house the pivot pin 135 on the central protrusion 124 of front crossbar 126. Thus, when steering cylinder 136 extends or retracts, it will turn the housing 150 to turn against the housing peg 159, and will cause the groove 157 to push the pivot pin 135 to make the cross movement and thus turn the front wheels 130/131 to turn. As shown in FIGS. 9A/9B, the bushing 146 is tangentially fitted inside the groove 181 of the steering control link 172 and can slide inside the groove 181 when sliding cylinder 142 extends or retracts, the bushing 146's movement inside the groove 181 will change the vehicle's steering mode from one to the other as follows:

When sliding cylinder 142 is extended, the bushing 146 will slides together with the sliding cradle 141 toward the right end 153 of the channel 151 and stop at the position just underneath the housing pin 158 so housing pin 158 and bushing 146 is vertically concentric to each other. In this position, the bushing 146, and thus the steering control link 172, will travel together with housing pin 158 when steering cylinder 136 extends or retracts. The movement of the control link 172 will then push the rear crossbar 102 to make the cross movement through the pivot rod 114 and thus the rear wheels 107/108 will also turn to the same direction and degree as the front wheel—so the motor vehicle is in crab travel mode when sliding cylinder 142 is extended.

When sliding cylinder 142 is retracted, the bushing 146 will slides together with the sliding cradle 141 toward the left end 152 of the channel 151 and stop at the position just underneath the housing peg 159 so housing peg 159 and bushing 146 are vertically concentric to each other. In this position, when steering cylinder 136 extends or retracts, the housing 151 will turn against the housing peg 159 and since the bushing 146 is underneath and concentric to housing peg 159 which is pivoted to the chassis, the bushing 146 will have no travel at all and thus the steering control link 172 will have no movement at all, so the rear wheels 107/108 will have no steering movement when the front wheels steer—so the motor vehicle is in front wheel steering mode when sliding cylinder 142 is retracted.

As shown in FIG. 13, the button switch 186 controls the power select valve 195 which distributes the power to the 3 wheel drive motors. When vehicle is in crab travel mode, button switch 186 is pressed by bushing 146 when it slides to just underneath the housing pin 158 and the power selective valve 195 will distribute the power to the front left wheel motor 129 and rear right motor 123. When vehicle is in front wheel steering mode, button switch 186 is not pressed and the power selective valve 195 will distribute the power to the front right wheel motor 134 and front left wheel motor 129.

### Steering Modes

It is an object of the present invention to accommodate four-wheeled steering of a motor vehicle. Within the present embodiment, two types of steering modes 210 and 200 are discussed, however, it should be understood that in alternative embodiments, there may be more or fewer types of steering depending on the user's needs. For the sake of simplicity, the types of steering discussed herein will be referred to as ‘steering modes”, but it should be understood that “steering mode” may refer to different configurations and positions of the wheels within the vehicle.

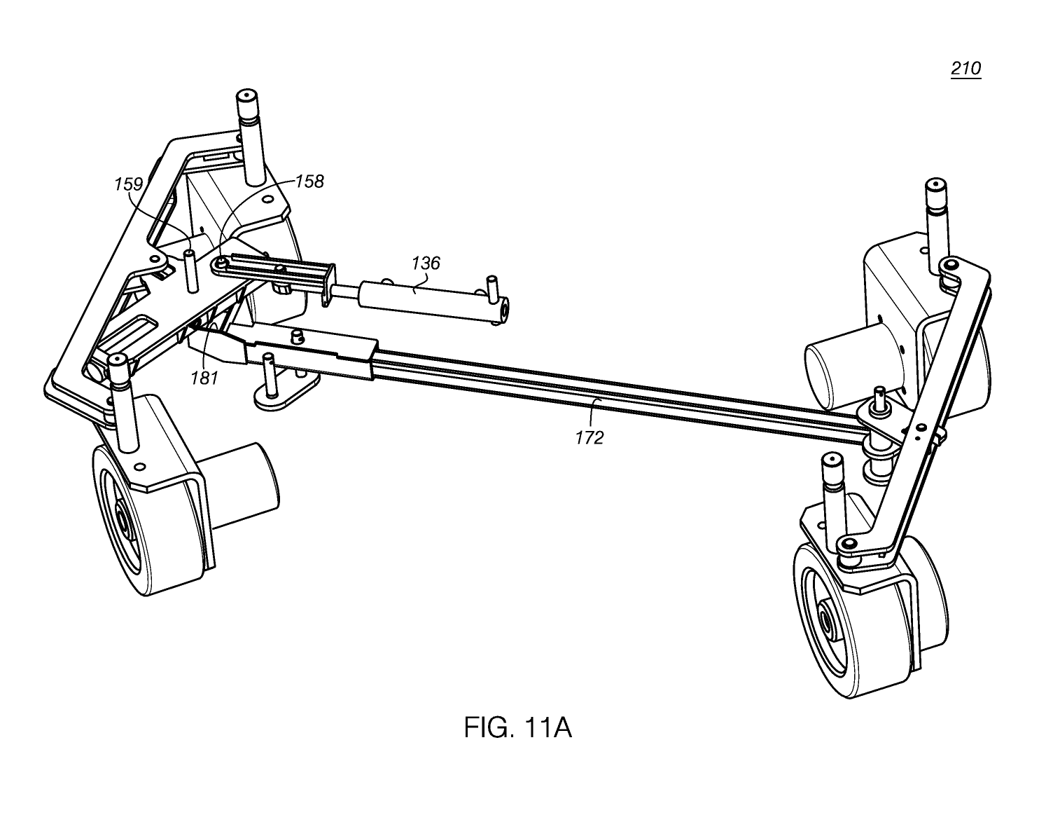

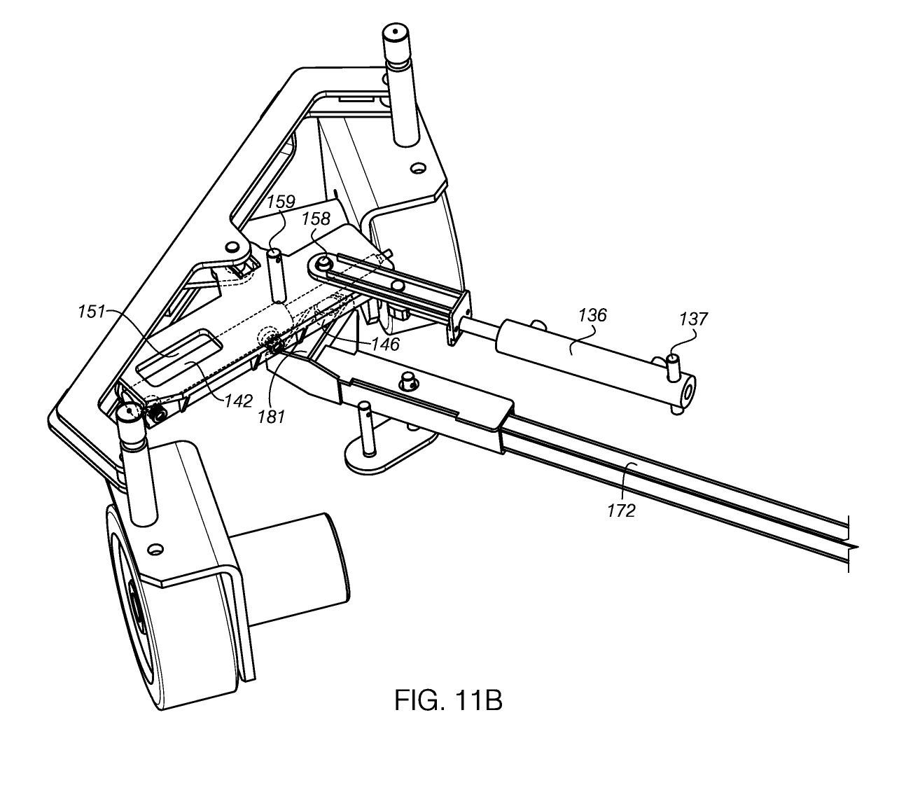

Referring now to FIGS. 11A and 11B, a first steering mode 210, descriptively referred to as “crab travel”, will be described. When the user selects first steering mode 210, sliding cylinder 142 will extend and push sliding cradle 141 to slide inside channel 151 to channel right side 153 and places lower peg 143 on the same side of housing pin 158 to the housing peg 159, such that lower peg 143 is just underneath of and, concentric to, housing pin 158. When steering cylinder 136 extends or retracts, housing 150 rotates around the center axis of housing peg 159. Lower peg 143, bushing 146, and housing pin 158 move together at the same distance and in the same direction. It should be understood that lower peg 143 is held in this position by sliding cylinder 142, thus when steering cylinder 136 extends or retracts, it turns housing 150 and the front wheels 130/131. Simultaneously, since lower peg 143 and bushing 146 move together with housing pin 158, they will push control link 172 to move in the same direction as the housing pin 158. Thus, control link 172 will turn the rear wheels 107/108 via the rear L-shape pivot arm 105 and rear crossbar 126 such that they turn at the same angle and in the same direction of the front wheels 130/131. In this manner, front wheels 130/131 turn in the same angle and the rear wheels 107/108 turn in the same angle and in the same direction as shown. Referring to FIG. 13, then, in crab travel mode, power selection valve 195 distributes power to the front left wheel drive motor 129 and rear right wheel motor 123. Front right wheel motor 134 is not activated in crab travel mode.

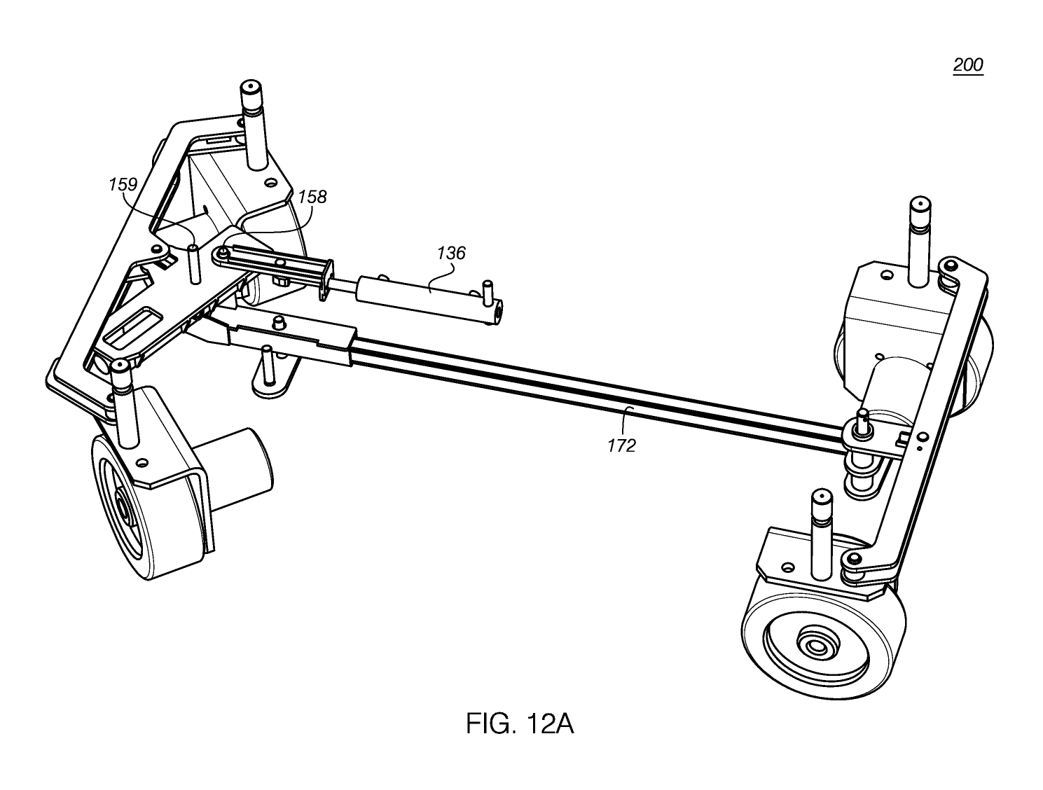

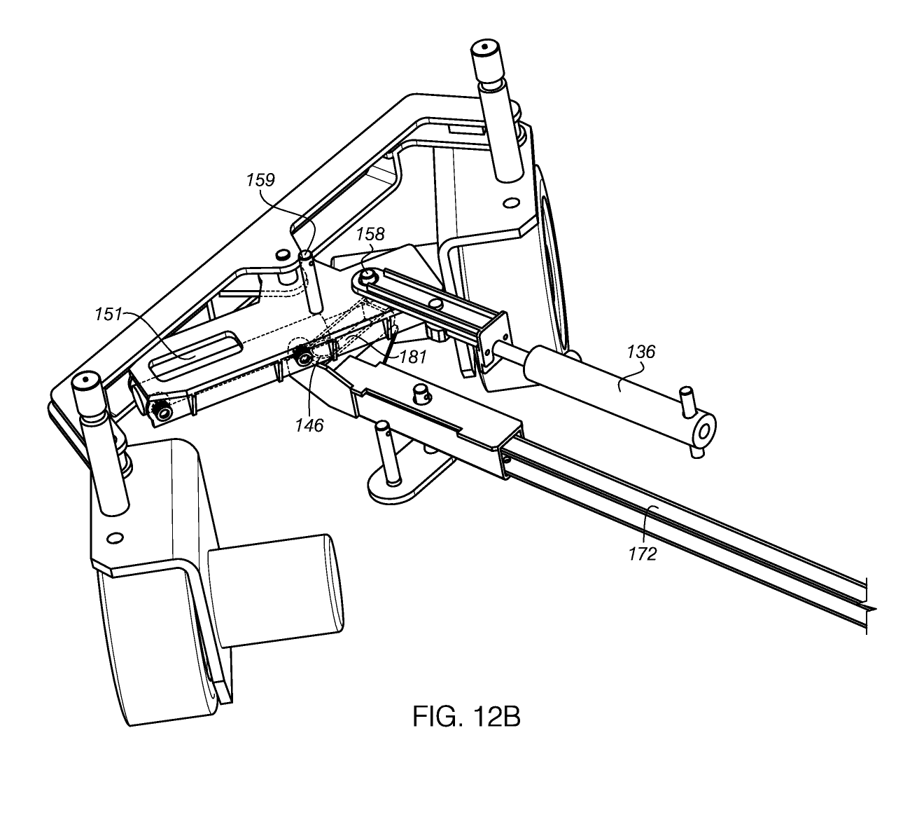

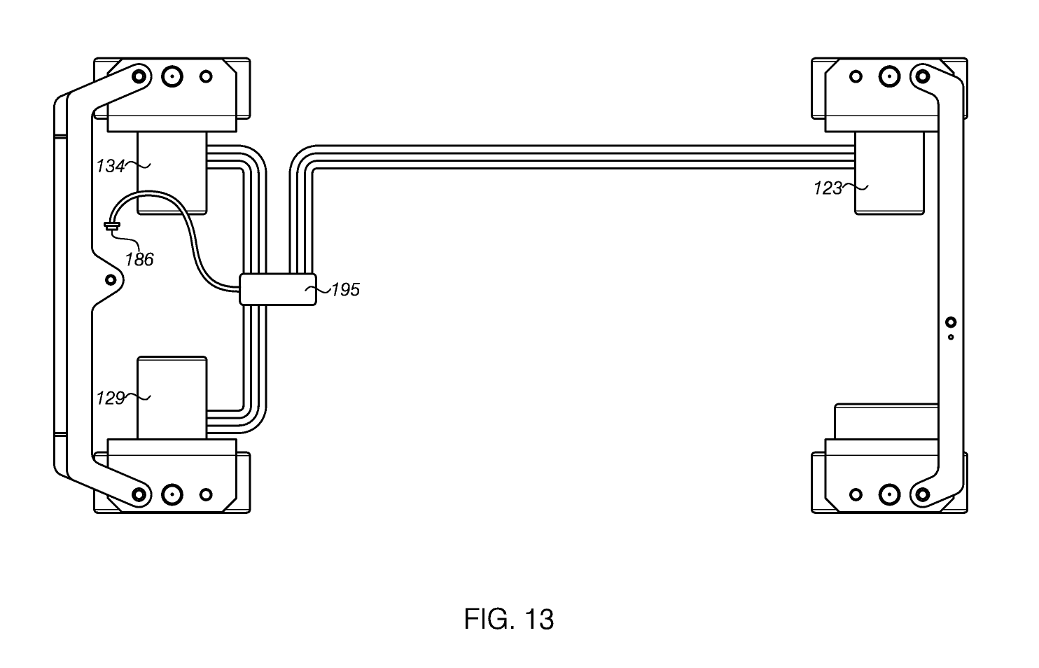

Referring to FIGS. 12A and 12B, a second steering mode 200, descriptively referred to as “front wheel steering” will be described. When the user selects second steering mode 200, sliding cylinder 142 will be retracted and push sliding cradle 141 to slide within channel 151 to channel left side 152 and places lower peg 143 and bushing 146 just underneath and concentric to housing peg 159 as shown. When steering cylinder 136 extends or retracts, it causes housing 150 to rotate around housing peg 159. Since lower peg 143 is now concentric to housing peg 159, lower peg 143 will not move at all when housing 150 is turned by the steering cylinder 136. Thus when steering cylinder 136 extends or retracts, it turns housing 150 and the front wheels 130/131, but the steering control link 172 will have no movement and the rear wheels 107/108 will not turn. As in first steering mode 210 and second steering mode 200, lower peg 143 is held stationary by sliding cylinder 142.

The disclosure above encompasses multiple distinct inventions with independent utility. While each of these inventions has been disclosed in a particular form, the specific embodiments disclosed and illustrated above are not to be considered in a limiting sense, as numerous variations are possible. The subject matter of the inventions includes all novel and nonobvious combinations and sub combinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and sub-combinations of the disclosed inventions that are believed to be novel and non-obvious. Inventions embodied in other combinations and sub combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A steering system for four-wheeled chassised motor vehicles having two front wheels and two rear wheels, the steering interchange system comprising:
a front wheel steering system configured to position the two front wheels;
a rear wheel steering system configured to position the two rear wheels;
a steering mode interchanger configured to change the rear wheels' relative position to the front wheels in order to form a plurality steering modes;
wherein turning direction of the rear wheels is relative to the turning direction of the front wheels, and said turning direction results in two different steering modes, the first of said two different steering modes of the vehicles further comprising a crab travel mode, the second of said two different steering modes further comprising a front wheels steering only mode.
a steering control link system configured to connect the steering mode interchanger to the rear wheel steering system; and
a steering cylinder comprising a rear end having a steering cylinder tube further comprising a tube aperture at the distal end of the tube and a front end having a steering cylinder rod having a rod aperture at the distal end of the rod, and wherein the front end is pivoted to the steering mode interchanger and the rear end is pivoted to the chassis.

2. The steering system of claim 1 wherein:
the front wheel steering system further comprises a front crossbar with having a front crossbar right arm and a front crossbar left arm;
the front crossbar right arm further having a front crossbar right aperture;
the front crossbar left arm further having a front crossbar left aperture; and
a front pivot pin disposed in the center of the front crossbar and substantially between front crossbar right arm and the front crossbar left arm of the front crossbar.

3. The steering system of claim 1, wherein the front wheel steering system further comprises:
a front right wheel bracket comprising a right front top plate having a front right pin and a front right peg;
wherein the front right pin pivots to the front crossbar right arm via the front right crossbar aperture and the front right peg is pivotally attached to the chassis;
and a right front vertical plate affixed to and at a substantially 90 degree angle to the right front top plate and wherein the right front wheel is attached to the right front vertical plate
a front left wheel bracket comprising a left front top plate having a front left pin and a front left peg;
wherein the front left pin pivots to the front crossbar left arm via the front left crossbar aperture and the front left peg is pivotally attached to the chassis;
and a left front vertical plate affixed to and at a substantially 90 degree angle to the left front top plate and wherein the left front wheel is attached to the left front vertical plate.

4. The steering system of claim 1 wherein:
the rear wheel steering system further comprises a rear crossbar with having a rear crossbar right arm and a rear crossbar left arm;
the rear crossbar right arm further having a rear crossbar right aperture;
the rear crossbar left arm further having a rear crossbar left aperture; and
a rear pivot rod disposed in the center of the rear crossbar and substantially between the rear crossbar right arm and the rear crossbar left arm of the rear crossbar.

5. The steering system of claim 1, wherein the rear wheel steering system further comprises:
a rear right wheel bracket comprising a rear right top plate having a rear right pin and a rear right peg;
wherein the rear right pin pivots to the rear right crossbar right arm via the rear right crossbar aperture and the rear right peg is pivotally attached to the chassis;
and a right rear vertical plate affixed to and at a substantially 90 degree angle to the rear right top plate and wherein the rear right wheel is attached to the rear right vertical plate
a rear left wheel bracket comprising a rear left top plate having a rear left pin and a rear left peg;
wherein the rear left pin pivots to the rear left crossbar arm via the rear left crossbar aperture and the rear left peg is pivotally attached to the chassis; and
and a rear left vertical plate affixed to and at a substantially 90 degree angle to the rear left top plate and wherein the rear left wheel is attached to the left front vertical plate.

6. The steering system of claim 1 wherein the steering control link system further comprises a rear L-shape pivot arm comprising:
a vertical tube
a rear L-shape pivot arm top plate wherein;
the rear L-shape pivot arm top plate comprises a rear L-shape pivot arm top plate first end and a rear L-shape pivot arm top plate second end;
a rear L-shape pivot arm top plate aperture disposed on the rear L-shape pivot arm top plate first end for accepting a rear L-shape pivot arm vertical tube;
a L-shape pivot arm top plate groove disposed on the rear L-shape pivot arm top plate second end for interacting with the rear wheel crossbar;
a rear L-shape pivot arm middle plate and wherein;
the rear L-shape pivot arm middle plate comprises a rear L-shape pivot arm middle plate first end and a rear L-shape middle plate second end;
a rear L-shape pivot arm middle plate first aperture disposed on the rear L-shape arm middle plate first end and fixed to the rear L-shape pivot arm vertical tube;
a rear L-shape pivot arm middle plate second aperture disposed on the front L-shape arm middle plate second end;
a rear L-shape pivot arm bottom plate wherein;
the rear L-shape pivot arm bottom plate comprises a rear L-shape pivot arm bottom plate first end and a rear L-shape pivot arm bottom plate second end;
a rear L-shape pivot arm bottom plate first aperture disposed on the rear L-shape arm middle plate first end and fixed to a rear L-shape pivot arm vertical tube; and
a rear L-shape pivot arm bottom plate second aperture disposed on the rear L-shape arm bottom plate second end.

7. The steering system of claim 6 wherein:
the rear L-shape pivot arm bottom plate second aperture is concentric to and aligns with the rear L-shape pivot arm middle plate second aperture;
the rear L-shape pivot arm bottom plate is parallel to the rear L-shape pivot arm middle plate; and
the rear L-shape pivot arm vertical tube coupling the rear L-shape pivot arm top plate, the rear L-shape pivot arm middle plate, and the rear L-shape pivot arm bottom plate together such that the rear L-shape pivot arm top plate always lies within a plane parallel to the planes for the rear L-shape pivot arm middle plate and the rear L-shape pivot arm bottom plate and wherein the longitudinal axis of the rear L-shape pivot arm top plate is perpendicular to the longitudinal axes of both the rear L-shape pivot arm middle plate and the rear L-shape pivot arm bottom plate; and
the vertical tube connects the rear L-shape pivot arm top plate, the rear L-shape pivot arm middle plate and the front L-shape pivot arm bottom plate together and also pivots the rear L-shape pivot arm to the chassis.

8. The steering system of claim 1 wherein the steering mode interchanger further comprises:
a housing having a channel with a right side, a left side, and a middle, a first aperture, a second aperture, a groove at the front, a housing pin on the upper surface at the distal end of the housing and a housing peg on the upper surface of the housing and adjacent to the groove;
wherein the first aperture and the second aperture are disposed on opposite ends of one side of the channel;
wherein the groove at the front is fitted to the pivot pin of the front crossbar and allows the pivot pin to slide inside and along the groove;
wherein the housing pin is pivotally connected to the steering cylinder front end via the rod aperture;
wherein the housing peg is pivotally coupled to the chassis;
a sliding cradle having a left side, a right side, lower peg, and a cradle aperture at the distal end of the cradle;
wherein the sliding cradle is fitted inside the channel and can slide along the channel;
a bushing affixed to the lower peg;
a sliding cylinder with cylinder tube having a first peg and a second peg and a cylinder rod having a threaded end and wherein the cylinder tube first peg is received by the first aperture on the channel, the cylinder tube second peg is received by second aperture on the channel, and the cylinder rod threaded end is received by the cradle aperture.

9. The steering system of claim 1 wherein the steering control link system further comprises:
a steering control link having a steering control link rear end and a steering control link front end wherein;
the steering control link rear end further comprises a rear aperture and the steering control link front end comprises a groove that is perpendicular to the steering control link and a front aperture; and
wherein the groove receives the bushing and allows the busing to slide inside the groove from the proximal to the distal end and the distal end to the proximal end of the groove.

10. The steering system of claim 1 wherein the steering control link system further comprises:
a front swing arm having a first pivot pin on the proximal end and a second pivot pin on the distal end, the proximal end being pivotally coupled to chassis and the second pivot pin being pivotally coupled to the front aperture of the steering control link.

11. The steering system of claim 10 wherein the rear end of the steering control link is pivotally coupled to the L-shape pivot arm and the front end of the steering control link is pivotally coupled to the front swing arm and the position of the front swing arm and L-shape pivot arm always move parallel to one another at opposite ends of the steering control link and wherein the movement of the steering control link is always parallel to the length of the chassis.

12. The steering system of claim 1 wherein:
the front wheels are controlled by the steering cylinder and the rear wheels are controlled by the steering cylinder and the sliding cylinder working in tandem.

13. The steering system of claim 1, wherein the crab travel mode further comprises the first of said plurality of steering modes wherein the sliding cylinder rod is fully extended, and wherein:
the sliding cradle slides inside the channel to the right side of the channel and places the lower peg of the sliding cradle on the same side of the housing pin to the housing peg;
the lower peg is just underneath of and concentric the housing pin;
the housing rotates about the center axis of the housing peg;
the lower peg and housing pin move together at the same distance and in the same direction;
the lower peg is held in this position by the sliding cylinder rod;
wherein when the steering cylinder rod extends or retracts, it turns the housing and the front wheels;
wherein when the steering cylinder rod extends or retracts, the lower peg pushes the steering control link via the bushing within the groove and wherein
the lower peg in the groove moves forward or backward the same distance and in the same direction as the housing pin;
the lower peg pushes the rear wheels via the rear L shape pivot arm and rear crossbar to turn at the same angle and in the same direction as the front wheels; and wherein
the front wheels and the rear wheels turn in the same angle and in the same direction.

14. The steering system of claim 1, the front wheels steering only mode further comprises the second of said plurality of steering modes wherein the sliding cylinder rod is retracted and wherein:
the sliding cradle slides inside the channel to the left side of the channel;
the lower peg moves to the center of channel and is just underneath and concentric to the housing peg;
when the steering cylinder rod extends or retracts to make the housing rotate around the center axis of the housing peg, the lower peg is held stationary by the sliding cylinder rod; and wherein
the rear wheels remain stationary and substantially parallel to the length of the chassis when the front wheels move in any direction.

15. The steering system of claim 1, wherein changing the orientation of the sliding cylinder or the L shape pivot arm by 180 degree will reverse the steering mode selection.

16. The steering system of claim 1, wherein the front wheel steering system and the rear wheel steering system further comprise:
at least one front wheel has a separate power source; and
at least one rear wheel has a separate power source.

17. The steering system of claim 8 wherein:
the pivot pin of the front wheel steering system is coupled to the groove at the front of the housing and can slides inside the groove;
the housing is driven by the steering cylinder rod to turn around the housing peg; and
the groove pushes the pivot pin and turns the front wheels via the front crossbar.

18. The steering system of claim 4 wherein:
the pivot rod is coupled to the top plate groove of the rear L-shape pivot arm and can slides inside the groove;
the L-shape pivot arm is turned around the L-shape pivot arm vertical tube by the steering control link;
the top plate groove of the rear L-shape pivot arm pushes the pivot rod on the rear crossbar; and
the rear wheels are turned by the rear crossbar.

19. The steering system of claim 13 wherein one front wheel and one rear wheel are powered.

20. The steering system of claim 14 wherein only the front wheels are powered.
